(19) United States
(12) Patent Application Publication
(10) Pub. No.: US 2014/0078135 A1
(43) Pub. Date: Mar. 20, 2014

(54) Virtual 3D Paper

(71) Applicant: SKY88 TECHNOLOGY LIMITED, Kowloon (HK)

(72) Inventor: SO KA YAN, Kowloon (HK)

(73) Assignee: SKY88 TECHNOLOGY LIMITED, Kowloon (HK)

(21) Appl. No.: 13/783,305

(22) Filed: Mar. 3, 2013

(30) Foreign Application Priority Data
Sep. 19, 2012 (HK) 12109185.2

(51) Int. Cl. G06T 15/10

(52) U.S. Cl. CPC G06T 15/10
USPC 345/419

(57) ABSTRACT

The invention discloses a virtual 3D paper, comprising data reader (1) for obtaining data, a multi touch gesture recognition engine (2) for receiving and recognizing multi touch signals, an event dispatching engine (3) for dispatching events according to the action of multi touch gesture recognition engine (2), an editing module (4) for editing data obtained by data reader (1), a rendering module (5) for rendering data edited by editing module (4), a display monitor (6) for displaying the rendered results of rendering module (5), and data exporter (7) for exporting the rendered results. The virtual 3D paper supports multi-point touch, may recognize kinds of gestures and read different types of files, and thus is more practical, more real and has a much better user experience.

### FIELD OF THE INVENTION

The invention relates to 3D technology field, more particularly, to a virtual 3D paper.

### BACKGROUND OF THE INVENTION

At present, most electronic products support single-point touch, and thus only relatively limited gestures can be recognized. Products like e-book belong to paper flipping animation technology, and only a few preset transitional animations of paper flipping can be displayed. At present e-book is not available for content editing, so the interaction with users is low.

### SUMMARY OF THE INVENTION

The objective of the present invention is to provide a virtual 3D paper having multi-touch points and recognizing plurality of gestures, aiming at the disadvantages in the prior art, such as single touch, bad gesture recognition capability, etc.

The technical solution of the present invention to solve the technical problem is: to provide a virtual 3D paper, comprising data reader for obtaining data, multi touch gesture recognition engine for receiving and recognizing multi-point touch signals, event dispatching engine for dispatching events in accordance with the action of multi touch gesture recognition engine, editing module for editing data obtained by data reader, rendering module for rendering data edited by editing module, display monitor for displaying the data from rendering module, and data exporter for exporting the rendered result.

Advantageously, the editing module comprises content editor for editing content, and graphic editor for editing graphics.

Advantageously, the rendering module comprises live content rendering engine for rendering content, and 3D graphic rendering engine for rendering graphics with 3D graphic process technology.

The virtual 3D paper of the invention also comprises geometry transformation engine for geometrically transforming graphics, geometry deformation engine for geometrically deforming graphics, network access interface for linking network, state management system for storing transformation states triggered by user or system signal, and sound play feature for audio playing.

Implementing the virtual 3D paper of the present invention, may achieve advantages as follows: the virtual 3D paper makes multi-point touch control available, a plurality of gestures recognizable, and kinds of documents readable, and gets more practical, more real, better at user experience, as well as more attractive to users.

### BRIEF DESCRIPTION OF THE DRAWINGS

To illustrate embodiments' technical solution of the invention , brief description of the accompanying drawings is to be introduced, and obviously, the accompanying drawings belong to some embodiments of the invention, and for the one skilled in the art, other figures also can be obtained according to the accompanying drawings below on condition that no innovative work are paid, and wherein:

FIG. 1 is the structure diagram of one embodiment of the virtual 3D paper of the invention;

FIG. 2 is the integrated structure diagram of one embodiment of the virtual 3D paper of the invention;

FIG. 3 is the basic schematic diagram of one embodiment of the virtual 3D paper of the invention;

FIG. 4 is the multi-point touch control schematic diagram of one embodiment of the virtual 3D paper of the invention;

FIG. 5 is the schematic diagram of flipping of one embodiment of virtual 3D paper of the invention;

FIG. 6 is the schematic diagram of curling of one embodiment of virtual 3D paper of the invention;

FIG. 7 is the schematic diagram of tearing of one embodiment of virtual 3D paper of the invention.

### DETAILED DESCRIPTION OF THE PREFERRED EMBODIMENT

To make the object, technical solution and advantages of the invention more clearly understood, the following description of embodiments is given, referring to the accompanying drawings which constitute parts of the embodiments, wherein, possible embodiments for implementing the invention have been described. It should be understood that other embodiments or the modification of the structure and function of the given embodiments may be made, without departing from the scope and substance of the invention.

The live interactive virtual 3D paper of the invention has functions as recognizing multi-touch gesture, simulating physical movement of real paper, simulating shape transformation of dynamic paper, simulating deformation of paper etc, as well as reading and editing kinds of data file sources and exporting the sources to other devices.

The particular embodiment of the virtual 3D paper of the invention comprises multi, touch and gesture recognition, graphic rendering, data processing and 3D model structure applied to 3D object of word processing field, graphic dialogue, and video games applied to the platform of mobile devices or personal computer. It allows users to incorporate the demo of real 3D files into the simple implementation in the software, and store the physical paper' s real features, comprising data writing, data displaying, data storing, flexibly moving, and flexibly shape transforming and deforming.

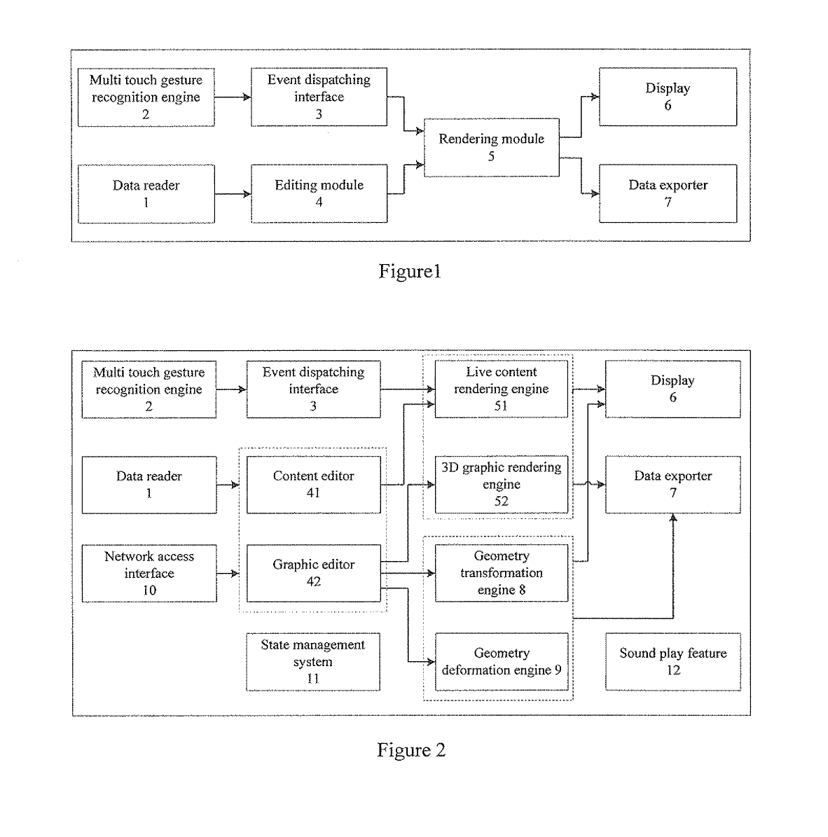

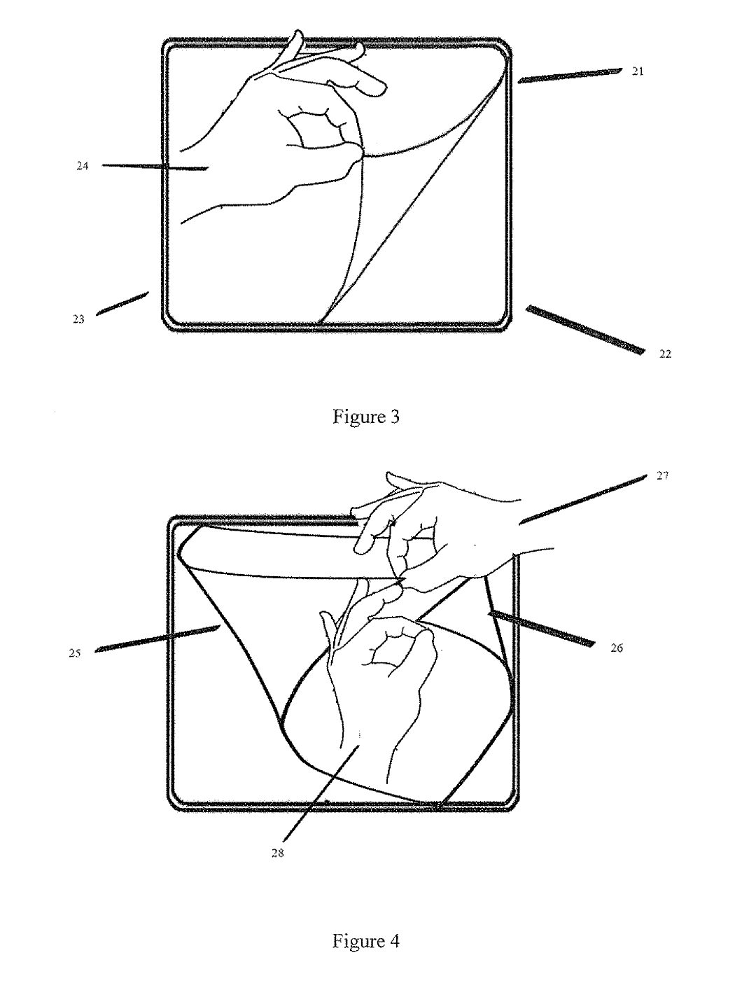

In one embodiment of the virtual 3D paper provided of the invention, as shown in FIG. 1, the virtual 3D paper comprises data reader 1, multi touch gesture recognition engine 2 for receiving and recognizing multi touch signals, event dispatching Interface 3 for dispatching events in accordance with the action of the multi touch gesture recognition engine 2, editing module 4 for editing data obtained by data reader 1, rendering module 5 for rendering data edited by editing module 4, display monitor 6 for displaying the rendered result of rendering module 5 and data exporter 7 for exporting the rendered results. Therein, editing module 4 comprises content editor 41 for editing content and graphic editor 42 for editing graphics; rendering module 5 comprises live content rendering engine 51 for rendering content and 3D graphic rendering engine 52 for 3D rendering graphics (as shown in FIG. 2).

As shown in FIG. 2, the virtual 3D paper of the invention also comprises geometry transformation engine 8 for geometrically transforming graphics, connected with graphic editor 42, geometry deformation engine 9 for geometrically deforming graphics, connected with graphic editor 42, network access interface 10 for network linking, state management system 11 for storing transformation state triggered by user or system signals, and sound play feature 12 for audio playing.

As to the modules of the virtual 3D paper of the invention, data importer 1, network access interface 10 and multi touch gesture recognition engine 2 belong to input layer, primarily for receiving external data or actions; event dispatching interface 3, content editor 41 and graphic editor 42 belong to input processing layer, primarily for processing the received data or actions; live content rendering engine 51, 3D graphic rendering engine 52, geometry transformation engine 8, geometry deformation engine 9 and state management system 11 belong to graphic rendering layer, mainly for rendering and managing data or graphics; display monitor 6, data exporter 7 and sound play feature 12 are used for exporting or displaying the rendered results.

The fundamental function of the virtual 3D paper of the invention is reading ASCII text file and graphic file and rendering those into virtual 3D paper model, which can be folded, rotated or curled in all directions and angles. When the virtual 3D paper is in operation, data importer 1 may read different kinds of standard data file formats e.g., text, png and jpg provided to procedure from data storage, and displaying them immediately on display monitor 6. Meanwhile, during the data input process, the accompanying sound will be played via sound play feature 12 which may playing common types of data such as MP3, wav, aiff.

The multi touch gesture recognition engine 2 of the virtual 3D paper of the invention is simultaneous multi touch interface, integrated with display monitor 6, ie can receive kinds of gestures and display kinds of information. Therein, any point on the multi touch interface can be accessible, permitting multi-touch input, rather than just single-point touch control. Furthermore, at least twenty kinds of multi touch gestures can be recognized and functions corresponding to gestures can be adjusted. Via various gestures control, the virtual 3D paper can be folded, scrolled, rotated, flipped, or maintain the shape as users want it to be. It means converting the whole file into another shape instead of displaying a few rotated flipping transitional animation. According to the input of user, the virtual 3D paper may be converted to various shapes, making file synchronically and flexibly moving with user's input.

Every input may trigger paper animations along with the input position and corresponding to the duration time, and the virtual 3D paper may scroll back to a particular point where the input is released. That is managed via reality transformation module (not shown in the accompanying drawings), most physical movements of the virtual 3D paper is simulated by 3D graphic rendering engine 52, and the 3D animations comprises flexible flipping, folding, shape transformation, live touch, drag movement, twisting, wrapping, force feedback and paper tearing.

State management system 11 for storing the transformed states triggered by user or the system signal, enhancing the quality of user experience by allowing the virtual 3D paper simulating more real feeling. A dynamic touch impression is expressed on display monitor 6 via movement of synchronized transformation and input.

The virtual 3D paper may be rendered and its size may be adjusted on both sides, and via 3D graphic rendering engine 52 the size adjusting can be made at any time, making streaming media content available. The virtual 3D paper is able to realize functions of editing and sharing collaborative content via network access interface 10. Appling live rendering algorithm, all animation can be rendered, making the content of paper updated at any time.

The content on the surface of the virtual 3D paper in the invention may be edited by editing module 4 (content editor 41 or graphic editor 42), including text editing, graphic drawing and painting, and even the transformation of the original shape. Therein, if the virtual 3D paper is torn by user, file or data stored therein will be destroyed accordingly, making the virtual 3D paper more practical and more attractive for users.

The virtual 3D paper in the invention is provided with network access interface 10, which enables cloud computing and instant large-scale update be sent out immediately, and allows content distribution server to distribute content more effectively.

The virtual 3D paper in the invention may be designed to be a reusable software, such as 3D games, poker game and so on, which may be put into another application program via API, Application Program Interface, by users, wherein, those similar independent application programs may not be reusable. The virtual 3D paper is designed to have the same appearance, feeling, touch and usage as real paper, may be applied to personal computer or multi touch mobile devices, and is supported by operating systems, including but not limited to MS Windows, Mac OS, IOS, and Android etc.

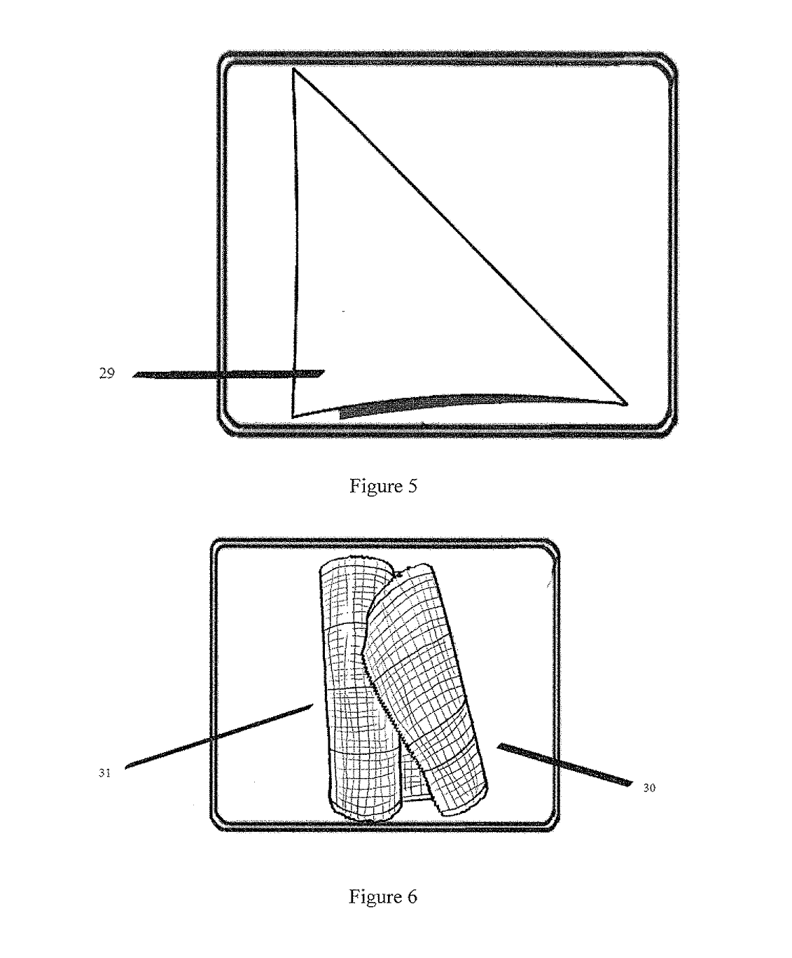

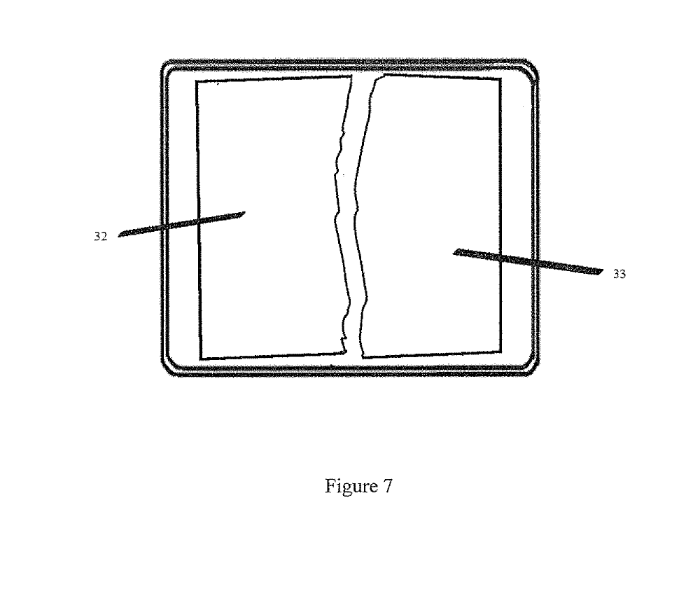

As shown in FIGS. 1-7, the applied embodiments of the virtual 3D paper of the invention have been illustrated, wherein, FIG. 3 illustrates the implementation based on a panel computer, being a multi touch panel 22, and the virtual 3D paper is displayed on the panel computer 21 and get a flipped shape by a user's hand 24. FIG. 4 illustrates the multi touch function of the virtual 3D paper, wherein the left side of the virtual 3D paper is transformed to a curled shape 25 by user's one hand 28, while the right side of the virtual 3D paper is transformed to another curled shape 26 by the other hand 27 of user. FIG. 5 illustrates the virtual 3D paper's complete transformation, i.e., the virtual 3D paper is folded into a triangle shape. FIG. 6 illustrates the advanced transforming function of the virtual 3D paper, that is, the left side 31 of the virtual 3D paper is scrolling back, and right side 30 of the virtual 3D paper is scrolling back. FIG. 7 illustrates the deformation feature of the virtual 3D paper, i.e., the virtual 3D paper is torn, wherein the left side 32 of the virtual 3D paper is torn and separated from the base paper, and the right side 33 of the virtual 3D paper is torn and separated from the base.

With the description to be given below, it should be understood by the skilled in the art that all features described in the article can be achieved via methods, data processing system or computer procedure products. Accordingly, the features can be expressed in hardware, software, or a combination of hardware and software. In addition, these features may also be realized by adopting the manner of a computer program product stored in one or more computer-readable storage media, comprising computer-readable program code segment or notation stored therein. Any useable computer-readable storage medium can be adopted, including hard disk, CD-ROM, optical storage device, magnetic storage device and/or the combination of the devices mentioned above.

The description above should be considered as preferable embodiments of the invention, it is known by the skilled in the art that various changes and equivalents of these features and embodiments can be made within the spirit and scope of the invention. In addition, these features and embodiments can be modified according to the instructions of the invention so as to adapt to particular situation and material, without departing from the spirit and scope of the present invention. Hence, the invention is not limited to the particular embodiments disclosed, but all embodiments within the scope of the claims should fall into the protection scope of the invention.

1. virtual 3D paper, wherein it comprises data reader (1) for obtaining data, multi touch gesture recognition engine (2) for receiving and recognizing multi-point touch signals, event dispatching engine (3) for dispatching events in accordance with the action of multi touch gesture recognition engine (2), editing module (4) for editing data obtained by data reader (1), rendering module (5) for rendering data edited by editing module (4), display monitor (6) for displaying the rendered results of rendering module (5) and data exporter (7) for exporting the rendered results.

2. The virtual 3D paper of claim 1, wherein the editing module (4) comprises content editor (41) for editing content, and graphic editor (42) for editing graphics.

3. The virtual 3D paper of claim 1, wherein the virtual 3D paper also comprises geometry transformation engine(8) for geometrically transforming graphics and geometry deformation engine (9) for geometrically deforming for graphics.

4. The virtual 3D paper of claim 3, wherein the rendering module (5) comprises live content rendering engine (51) for rendering content and 3D graphic rendering engine (52) for 3D rendering graphics.

5. The virtual 3D paper of claim 1, wherein the virtual 3D paper also comprises network access interface (10) for network linking.

6. The virtual 3D paper of claim 1, wherein the virtual 3D paper also comprises state management module (11) for storing transformation states triggered by user or system signal.

7. The virtual 3D paper of claim 1, wherein the virtual 3D paper also comprises sound play feature (12) for audio playing.
